(19) United States
(12) Patent Application Publication
(10) Pub. No.: US 2020/0327587 A1
(43) Pub. Date: Oct. 15, 2020

(54) AIRCRAFT TAXI COST DETERMINATION SYSTEMS AND METHODS

(71) Applicant: THE BOEING COMPANY, Chicago, IL (US)

(72) Inventors: Ralf Rene Shu-Zhong Cabos, Hainburg (DE); Nils Kneuper, Bergkamen (DE)

(73) Assignee: THE BOEING COMPANY, CHICAGO, IL (US)

(21) Appl. No.: 16/383,729

(22) Filed: Apr. 15, 2019

(51) Int. Cl. G06Q 30/02; G06Q 50/30

(52) U.S. Cl. CPC G06Q 30/0284; G08G 5/06; G06Q 50/30

(57) ABSTRACT

Aircraft taxi cost determination systems and methods include a taxi cost determination control unit that determines a total cost of one or more available taxi scenarios for an aircraft at an airport based on fuel cost, engine cost, crew cost, and maintenance cost for the available taxi scenario(s).

### FIELD OF THE DISCLOSURE

Embodiments of the present disclosure generally relate to aircraft taxi cost determination systems and methods, and more particularly to systems and methods that are configured to determine costs for taxi options for aircraft at an airport.

### BACKGROUND OF THE DISCLOSURE

Various types of aircraft are used to transport passengers and cargo between various locations. Each aircraft typically flies between different locations according to a defined flight plan or path.

An airport typically includes numerous gates at which aircraft are positioned to allow passengers to board the aircraft. The aircraft at the gate is on a tarmac that connects to a runway through one or more taxiways. After the aircraft pushes back from the gate, the aircraft taxis to the runway via the taxiway(s).

Typically, a taxiing process is performed based on only a few constraints, such as a maximum taxi speed and traffic on airport surfaces. On a taxiway, a flight crew maneuvers an aircraft by pushing thrust levers to an arbitrary position, without knowing whether an associated level of thrust is cost effective. For example, an increased amount of thrust may cause the aircraft to move at an increased speed and arrive at an end of the taxiway in a short period of time, but the engines may burn an increased amount of fuel due to the directed amount of thrust, which therefore increases fuel cost.

### SUMMARY OF THE DISCLOSURE

A need exists for a system and method for determining various taxiing options for aircraft. Further, a need exists for a system and method for providing costs for one or more taxiing options.

With those needs in mind, certain embodiments of the present disclosure provide an aircraft taxi cost determination system that includes a taxi cost determination control unit that determines a total cost of one or more available taxi scenarios for an aircraft at an airport based on fuel cost, engine cost, crew cost, and maintenance cost for the available taxi scenario(s).

The aircraft taxi cost determination system may also include an environmental sub-system that is in communication with the taxi cost determination control unit. The environmental sub-system stores environmental data. The taxi cost determination control unit analyzes the environmental data when determining the total cost of the available taxi scenario(s).

The aircraft taxi cost determination system may also include an airport database that is in communication with the taxi cost determination control unit. The airport database stores airport data. The taxi cost determination control unit analyzes the airport data when determining the total cost of the available taxi scenario(s).

The aircraft taxi cost determination system may also include an aircraft database that is in communication with the taxi cost determination control unit. The aircraft database stores aircraft data regarding the aircraft. The taxi cost determination control unit analyzes the aircraft data when determining the total cost of the available taxi scenario(s).

The aircraft taxi cost determination system may also include a flight schedule sub-system that is in communication with the taxi cost determination control unit. The flight schedule sub-system stores flight schedule data for the airport. The taxi cost determination control unit analyzes the flight schedule data when determining the total cost of the available taxi scenario(s).

In at least one embodiment, the taxi cost determination control unit accounts for engine warm-up time for the aircraft when determining the total cost of the available taxi scenario(s). In at least one embodiment, the taxi cost determination control unit accounts for a required time frame within which the aircraft is required to take off when determining the total cost of the available taxi scenario(s). In at least one embodiment, the taxi cost determination control unit accounts for a number of stop bars on a taxiway when determining the total cost of the available taxi scenario(s).

In at least one embodiment, the taxi cost determination control unit establishes possible taxi scenarios based on one or more of environmental data, taxi data, aircraft data, airport data, or flight schedule data. The taxi cost determination control unit discards one or more possible taxi scenarios that are outside of a required time frame as one or more unavailable taxi scenarios. The taxi cost determination control unit identifies one or more possible taxi scenarios that are within the required time frame as the one or more available taxi scenarios. The taxi cost determination control unit identifies a lowest cost available taxi scenario within the available taxi scenarios.

Certain embodiments of the present disclosure provide an aircraft taxi cost determination method that includes determining, by a taxi cost determination control unit, a total cost of one or more available taxi scenarios for an aircraft at an airport based on fuel cost, engine cost, crew cost, and maintenance cost for the one or more available taxi scenarios.

The aircraft taxi cost determination method may also include analyzing (by the taxi cost determination control unit) environmental data during the determining, analyzing (by the taxi cost determination control unit) airport data during the determining, analyzing (by the taxi cost determination control unit) aircraft data during the determining, and/or analyzing (by the taxi cost determination control unit) flight schedule data during the determining.

The aircraft taxi cost determination method may also include accounting for (by the taxi cost determination control unit) one or more of engine warm-up time for the aircraft, a required time frame within which the aircraft is required to take off, or a number of stop bars on a taxiway during the determining.

In at least one embodiment, the determining includes establishing possible taxi scenarios based on one or more of environmental data, taxi data, aircraft data, airport data, or flight schedule data, discarding one or more possible taxi scenarios that are outside of a required time frame as one or more unavailable taxi scenarios, identifying one or more possible taxi scenarios that are within the required time frame as the one or more available taxi scenarios, and identifying a lowest cost available taxi scenario within the one or more available taxi scenarios.

### BRIEF DESCRIPTION OF THE DRAWINGS

FIG. 1 illustrates a schematic block diagram of an aircraft taxi cost determination system, according to an embodiment of the present disclosure.

FIG. 2 illustrates a simplified schematic diagram of a taxiway of an airport.

FIG. 3 illustrates a graph of taxi costs over time.

FIG. 4 illustrates equations for determining total taxi cost, according to an embodiment of the present disclosure.

FIG. 5 illustrates a simplified top view of an aircraft on a taxiway.

FIG. 6 illustrates a graph of a speed of the aircraft on the taxiway over time.

FIG. 7 illustrates a graph of distance of the between the aircraft and a target location on the taxiway over time.

FIG. 8 illustrates a graph of thrust force of the aircraft on the taxiway over time.

FIG. 9 illustrates a graph of accumulated taxi cost in relation to time.

FIG. 10 illustrates a flow chart of an aircraft taxi determination method, according to an embodiment of the present disclosure.

FIG. 11 is a diagrammatic representation of a front view of a display showing available taxi scenarios, according to an embodiment of the present disclosure.

FIG. 12 is a diagrammatic representation of a front perspective view of an aircraft, according to an exemplary embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition may include additional elements not having that condition.

Certain embodiments of the present disclosure provide aircraft taxi cost determination systems and methods that account for costs of taxiing at an airport. The taxi determination systems and methods are configured to determine efficient taxiing strategies for an aircraft. Notably, if an aircraft taxies fast, costs growing with time are reduced, but fuel and engine wear costs may increase. Conversely, if the aircraft taxies slow, fuel costs may be reduced, but the total time of taxiing increased, which may increase time dependent costs. Certain embodiments of the present disclosure are configured to define a total taxi cost function in which various factors are considered when searching for an efficient, cost-efficient taxiing strategy.

Certain embodiments of the present disclosure determine a cost-efficient taxiing strategy, in order to reduce overall and specific operation costs, including fuel, engine leasing, maintenance, and crew. The aircraft taxi cost determination systems and methods account for costs associated with fuel, maintenance, crew and engine cost.

Certain embodiments of the present disclosure provide an aircraft taxi cost determination system that includes a taxi cost determination control unit that is configured to collect data related to aircraft and environmental features and calculate multiple taxi scenarios. The taxi costs determination control unit is further configured to select a taxi scenario representing a lowest overall cost. Certain embodiments of the present disclosure provide an aircraft taxi determination method that includes collecting a plurality of data types related to multiple aspects of the aircraft taxi process, calculating multiple taxi scenarios based on the collected data, and predicting the taxi scenario representing a lowest overall cost.

FIG. 1 illustrates a schematic block diagram of an aircraft taxi cost determination system 100, according to an embodiment of the present disclosure. The aircraft taxi cost determination system 100 includes a taxi cost determination control unit 102. A display 104, such as a monitor, screen or the like, which may onboard an aircraft, may be in communication with the taxi cost determination control unit 102, such as through one or more wired or wireless connections. An input device 106, such a keyboard, mouse, touchscreen, or the like, which may onboard an aircraft, may also be in communication with the taxi cost determination control unit 102, such as through one or more wired or wireless connections. In at least one embodiment, the taxi cost determination control unit 102, the display 104, and the input device 106 may be in a common housing, such as a flight computer onboard an aircraft. In at least one other embodiment, the taxi cost determination control unit 102 may be remotely located from one or both of the display 104 and/or the input device 106. For example, the taxi costs determination control unit 102 may be at a central monitoring location within an airport, while the display 104 and the input device 106 may be part of a flight computer onboard an aircraft.

The taxi cost determination control unit 102 may be in communication with an environmental sub-system 108, such as through one or more wired or wireless connections. The taxi cost determination control unit 102 and the environmental sub-system 108 may be at the same location or different locations. The environmental sub-system 108 stores environmental data 110 regarding a location at which an aircraft is situated, such as an airport. The environmental data 110 may include wind vector and speed, temperature, air pressure, humidity, and/or the like. In at least one embodiment, the environmental sub-system 108 may be or include a meteorological service.

The taxi cost determination control unit 102 may also be in communication with an airport database 112, such as through one or more wired or wireless connections. The taxi cost determination control unit 102 and the airport database 112 may be at the same location or different locations. The airport database 112 stores airport data 114 for the airport at which an aircraft is currently located. For example, the airport data 114 may include information regarding taxiways, runways, and the like at the airport.

The taxi cost determination control unit 102 may also be in communication with an aircraft database 116, such as through one or more wired or wireless connections. The taxi cost determination control unit 102 and the aircraft database may be at the same location or different locations. The aircraft database 116 stores aircraft data 118 for an aircraft. For example, the aircraft data 118 may include information regarding an actual mass of the aircraft, a static friction component, and/or the like.

The taxi cost determination control unit 102 may also be in communication with a flight schedule sub-system 120, such as through one or more wired or wireless connections. The taxi cost determination control unit 102 and the flight schedule sub-system 120 may be at the same location or different locations. The flight schedule sub-system 120 stores flight schedule data 122 for an airport. The flight schedule data 122 includes scheduled departure and arrival times for aircraft at the airport.

In operation, the taxi cost determination control unit 102 analyzes one or more of the environmental data 110, the airport data 114, the aircraft data 118, and the flight schedule data 122 to determine a cost-efficient taxiing strategy for an aircraft. In at least one embodiment, the taxi cost determination control unit 102 determines a cost of at least one available taxi scenario for an aircraft at an airport based on a total cost of taxiing, which factors in the environmental data, the airport data, the aircraft data, and the flight schedule data. The taxi cost determination control unit 102 may show one or more taxiing options, such as the most cost-efficient taxiing strategy, on the display 104.

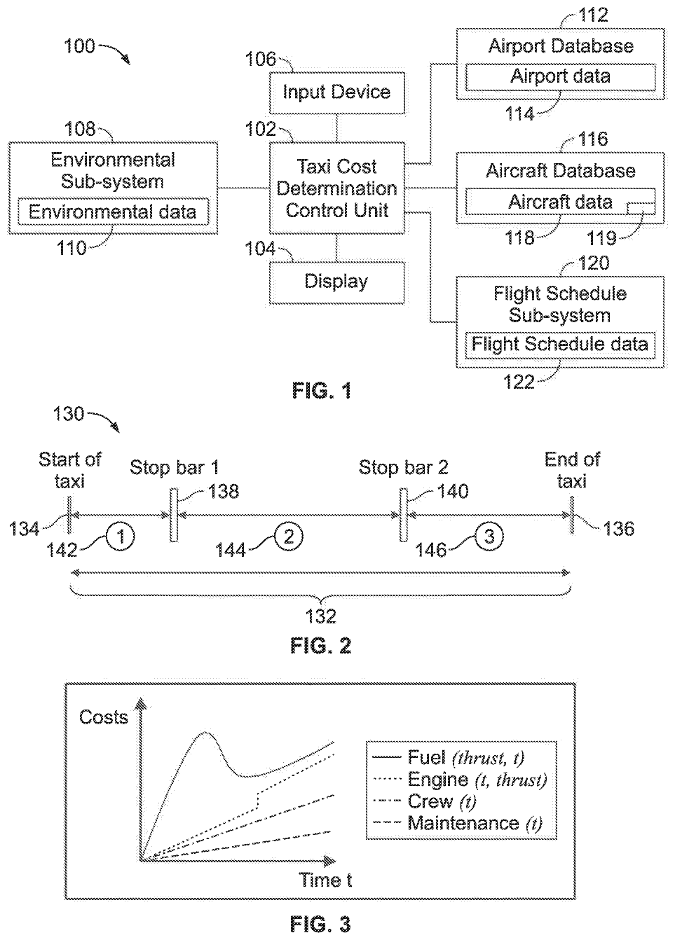

FIG. 2 illustrates a simplified schematic diagram of a taxiway 130 of an airport. The taxiway 130 has a distance 132 from a starting point 134 to an end point 136. Between the starting point 134 and the end point 136, one or more stop bars 138 and 140 may be positioned. The stop bars 138 are areas on the taxiway 130 at which an airport is required to stop for at least a predetermined period of time. As such, during a taxiing process, an aircraft may move on the taxiway 130 during a first stage 142 between the starting point 134 and the stop bar 138, at which point the aircraft stops. A second stage 144 extends between the stop bar 138 and the stop bar 140. The aircraft moves on the taxiway 130 during the second stage between the stop bar 138 and the stop bar 140, at which point the aircraft again stops. A third stage 146 extends between the stop bar 140 and the end point 136. The aircraft moves on the taxiway 130 during the third stage 146 between the stop bar 140 and the end point 136, which leads to a runway.

Referring again to FIG. 1, the taxi cost determination control unit 102 determines a total taxi cost for an aircraft based on the following:

Total Taxi Cost=Fuel Cost+Engine Cost+Maintenance Cost+Crew Cost

As shown above, the total taxi cost equals the fuel cost, the engine cost, the maintenance cost, and the crew cost. That is, the total tax cost is the sum of all the noted cost factors. The taxi cost determination control unit 102 determines a total taxi cost on numerous cost factors. In at least one embodiment, the taxi cost determination control unit 102 is configured to determine the costs of one or more taxi scenarios (that is, options for an aircraft to taxi) based on fuel cost, engine cost, maintenance cost, and crew cost. Instead of just determining fuel cost or a time of taxiing, the taxi cost determination control unit 102 determines a comprehensive total taxi cost that accounts for various costs associated with taxiing.

The fuel cost is a function of thrust over time. For example, fuel is burned as the engines of an aircraft provide thrust over time. An increased amount of fuel burn increases fuel cost. In at least one embodiment, the fuel cost is part of the aircraft data 118.

The engine cost also depends on thrust. For example, the engine cost is based on the following:

Engine Cost=Cost_{Eng}(t)+SpecialCost(thrust)

As shown, the engine costs equals the cost of the engine, such as a leasing cost of the engine, over time (such as a time of a leasing contract) plus an additional special cost that is a function of thrust. Engine leasing costs may be set at a constant hourly rate. The special cost may be an engine leasing cost that is covered for cases in which an engine manufacturer demands extra fees for exceptional thrust, such as maximum take-off thrust. For example, the special cost may be additional costs that are applied when an engine is operated at or above a predefined threshold (such as a percentage of total possible thrust, a particular rate or time of use, and/or the like). In at least one embodiment, the engine cost is part of the aircraft data 118.

The maintenance cost depends on time. For example, the maintenance cost is based on the following:

Maintenance Cost=Cost_{Mx}(t)

As shown, the total maintenance costs is the cost of maintenance (that is Cost_{Mx}), which includes labor costs, parts costs, etc., which is known to an airline over time. In at least one embodiment, the maintenance cost is part of the aircraft data 118.

The crew cost also depends on time. For example, the crew cost is based on the following:

Crew Cost=Cost_{cabin}(t)+Cost_{FlightDeck}(t)

As shown, the total crew cost is the cost of cabin crew (such as flight attendants) over time plus the cost of flight deck (such as pilot and co-pilot) over time. In at least one embodiment, the crew cost is part of the aircraft data 118.

FIG. 3 illustrates a graph of taxi costs over time. The fuel cost, the engine cost (such as engine leasing cost), the maintenance cost, and the crew costs affect the total cost of taxiing. The fuel cost depends on thrust level and time. Similarly, the engine cost depends on thrust level and time. The maintenance cost and the crew cost depend on time. Referring to FIGS. 1 and 3, the taxi cost determination control unit 102 determines a total taxi cost based on fuel cost, engine cost, maintenance cost, and crew cost.

In at least one embodiment, the taxi cost determination control unit 102 may also analyze one or more boundary conditions. For example, the taxi cost determination control unit 102 may take account of engine warm-up time for an aircraft. The engine warm-up time is a required minimum amount of time for engines of an aircraft to warm-up before being allowed to take off, and may be a function of aircraft type. The engine warm-up time may be part of the aircraft data 118.

Another boundary condition may be time constraints. For example, the taxi cost determination control unit 102 may account for a required time frame within which the aircraft is required to take off. For example, the flight schedule data 122 includes a latest time at which the aircraft is able to depart from the airport.

Another boundary condition may be a number of stop bars. For example, the taxi cost determination control unit 102 may account of a required number of stop bars along a taxiway. Information regarding the taxiway and the stop bars is stored in the airport data 114.

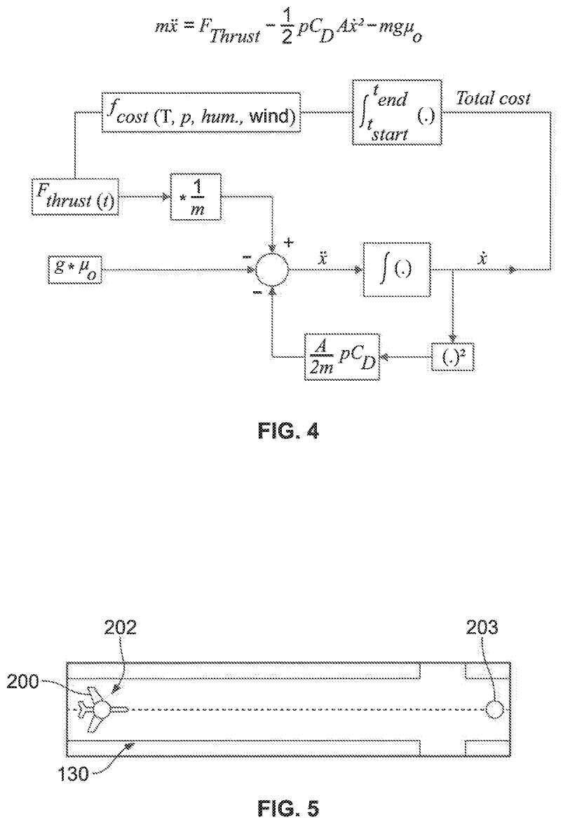

FIG. 4 illustrates equations for determining total taxi cost, according to an embodiment of the present disclosure. As shown in FIG. 4, the taxi cost determination control unit 102 may determine acceleration and velocity values for a taxiing strategy, in which m is the mass of the aircraft, F_{Thurst} is the exerted thrust force, p is the drag at wheels of the aircraft by the surface of the taxiway, C_{D} is the coefficient of drag of the aircraft, A is the area of the aircraft affected by drag (such as an outer surface of the aircraft), g is gravitational acceleration, and μ₀ the coefficient of static friction.

FIG. 5 illustrates a simplified top view of an aircraft 200 on the taxiway 130. The aircraft 200 is at a current position 202 and is to move to a target location 203, such as an entrance to a runway.

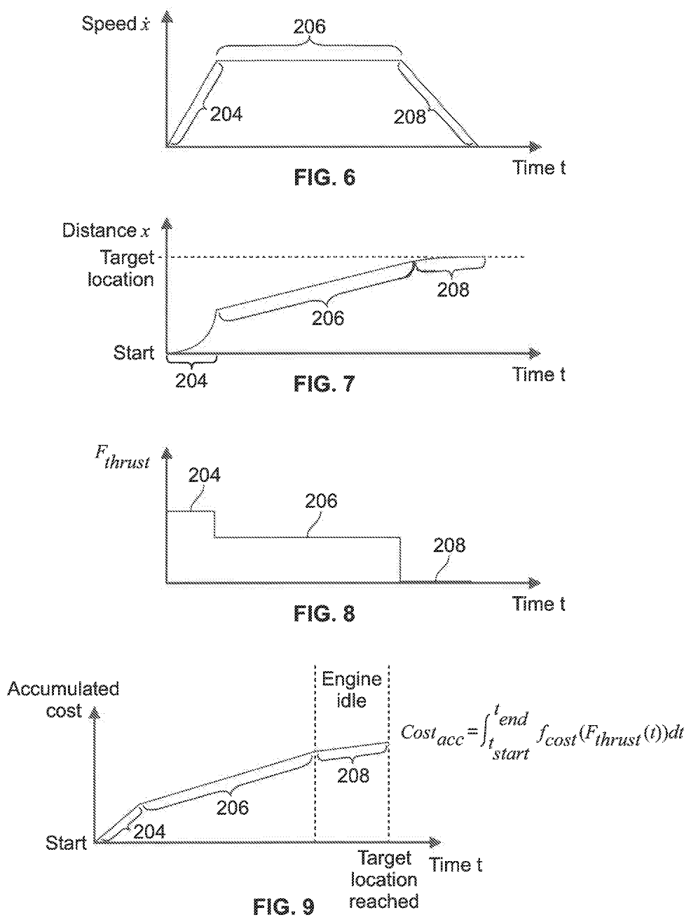

FIG. 6 illustrates a graph of a speed of the aircraft 200 on the taxiway 130 over time. FIG. 7 illustrates a graph of distance of the between the aircraft 200 and the target location 203 on the taxiway 130 over time. FIG. 8 illustrates a graph of thrust force of the aircraft 200 on the taxiway 130 over time. FIG. 9 illustrates a graph of accumulated taxi cost in relation to time. Referring to FIGS. 5-9, the aircraft 200 initially gains speed (such as through increased thrust force) through acceleration during time 204 to begin moving towards the target location 203. After reaching a desired speed, the aircraft maintains the desired speed over a time 206. After the time 206, the aircraft idles for time 208, which allows the aircraft to roll to the target location 203. As shown in FIG. 9, the cost of taxiing rate is greatest at time 204, and lowest at time 208. However, the total accumulated cost of taxiing includes the costs of the times 204, 206, and 208, from a start point (that is, the position 202 shown in FIG. 5) to an end point (that is, the target location 203). Notably, the total cost is dependent on thrust.

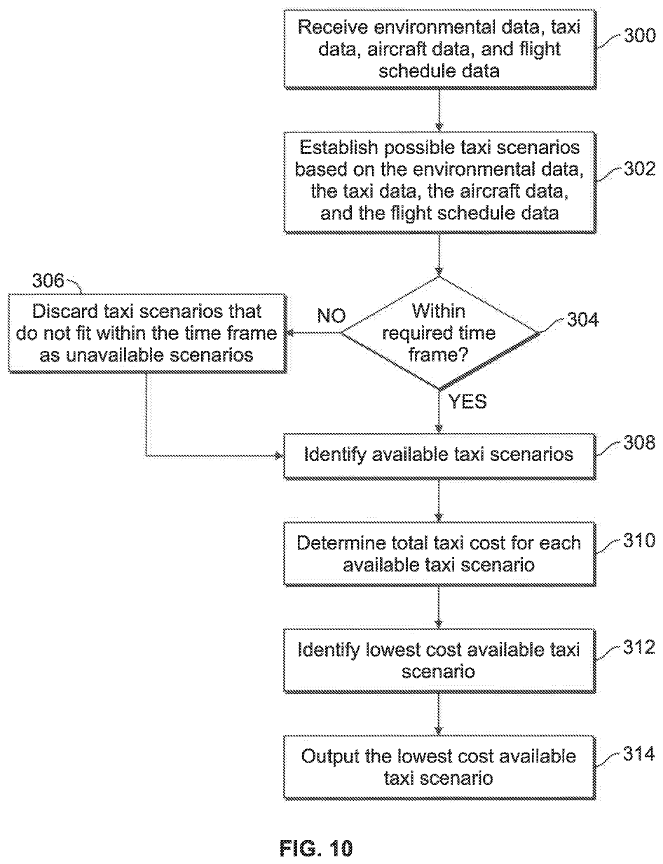

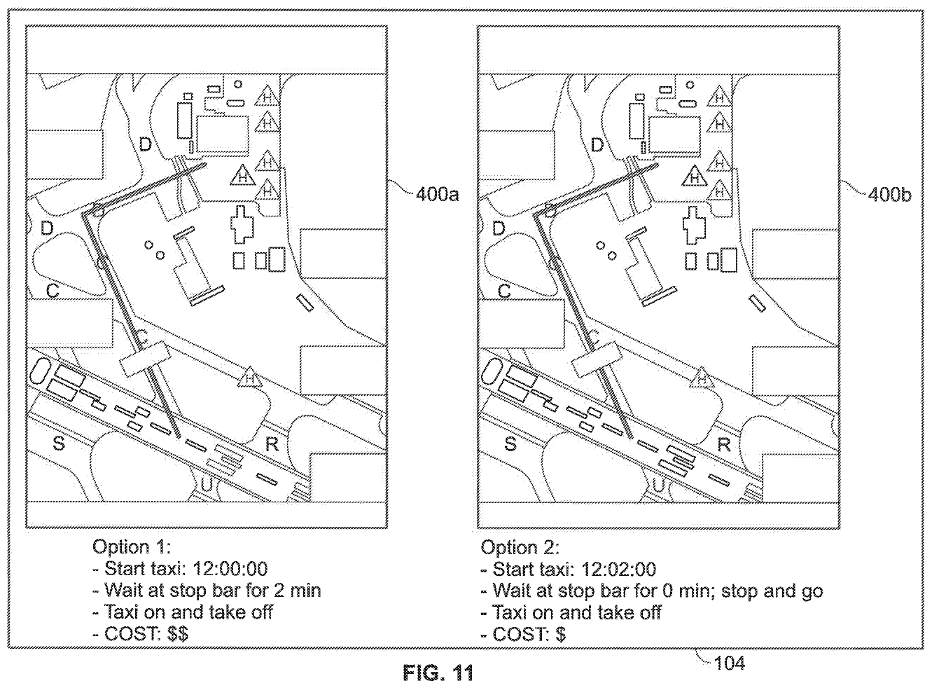

FIG. 10 illustrates a flow chart of an aircraft taxi determination method, according to an embodiment of the present disclosure. Referring again to FIGS. 1 and 10, at 300, the taxi costs determination control unit 102 receives the environmental data 110, the aircraft data 118 (which may include taxi data 119, the airport data 114, and the flight schedule data 122. As explained herein, the taxi costs determination control unit 102 analyzes the environmental data 110, the airport data 114, the aircraft data 118, and/or the flight schedule data 122 when determining costs of taxi scenarios.

The environmental data 110 may include wind vector and speed, temperature, air pressure, humidity, and gravitational acceleration. The airport data 114 and/or the flight schedule data 122 may include the taxi data 119, which may be input into the taxi cost determination control unit 102, such as through the input device 106. For example, the airport data 114 may include a distance to be traveled to a target location (such as the target location 203 shown in FIG. 5), an earliest point in time to arrive at the target location (which may either be input, or retrieved from the flight schedule data 122), a latest point in time to arrive at the target location (which may either be input, or retrieved from the flight schedule data 122), a maximum taxi speed, and a minimum taxi speed. The aircraft data 118 may include the actual mass of the aircraft 200 (shown in FIG. 5), a static friction component (such as of the aircraft and/or the taxiway), and/or the like.

At 302, the taxi cost determination control unit 102 establishes possible taxi scenarios based on the environmental data 110, the taxi data 119, the aircraft data 118, the airport data 114, and/or the flight schedule data 122. In response to receiving the environmental data 110, the airport data 114, the aircraft data 118, and/or the flight schedule data 122, the taxi cost determination control unit 102 establishes possible taxi scenarios. In at least one embodiment, the taxi cost determination control unit 102 establishes all possible taxi scenarios, which includes all possible quantitative acceleration and speed values. For example, the taxi cost determination control unit 102 may establish an array of quantitatively different acceleration instances (for example, 1 m/s², 1.5 m/s², 2 m/s², . . . n m/s²). The taxi cost determination control unit 102 may also establish an array of quantitatively different speed instances (for example, 1 m/s, 1.5 m/s, 2 m/s, . . . n m/s). The taxi cost determination control unit 102 may then provide combinations of each acceleration instance and each speed instance (for example, 1 m/s² and 1 m/s, 1 m/s² and 1.5 m/s, 1 m/s² and 2 m/s, . . . n m/s² and n/s).

At 304, the taxi cost determination control unit 102 determines whether each possible taxi scenario is within a required time frame. If a possible taxi scenario is not within a required time frame at 304, the taxi cost determination control unit 102 discards the possible taxi scenarios that do not fit within the required time frame as unavailable taxi scenarios at 306. If the possible taxi scenarios are within the required time frame at 304 (and/or those that have not been discarded at 306), the method proceeds to 308, at which the taxi cost determination control unit 102 identifies such taxi scenarios as available taxi scenarios. For example, certain taxi scenarios may not reach the target location 203 (shown in FIG. 5) within a time frame as indicated in the flight schedule data 122. For example, a taxi scenario of an aircraft traveling 500 feet in 2 hours may be ignored by the taxi cost determination control unit 102 and discarded as unavailable. Accordingly, the taxi cost determination control unit 102 identifies available taxi scenarios by removing time restricted scenarios from the possible taxi scenarios.

Next, after determining the available taxi scenarios at 308, the taxi cost determination control unit 102 determines a total taxi cost for each available taxi scenario at 310. For example, the taxi cost determination control unit 102 may determine the total taxi cost for each available taxi scenario based on the following:

Total Taxi Cost=Fuel Cost+Engine Cost+Maintenance Cost+Crew Cost

At 312, the taxi cost determination control unit 102 then determines the lowest cost available taxi scenario. For example, out of all the available taxi scenarios, each has a determined total taxi cost. The taxi cost determination control unit 102 identifies the lowest determined total taxi cost as the lowest cost taxi scenario. At 314, the taxi cost determination control unit 102 may then output the lowest cost available taxi scenario, which may be shown on the display 104.

In at least one embodiment, the taxi cost determination control unit 102 may determine a roll-out distance and time if aircraft engines are returned to idle for the aircraft to stop moving for each combination of acceleration instance and speed instance. Thus, the taxi cost determination control unit 102 may generate plurality of combinations of acceleration instance, speed instance, and time. For each of such triplets, the taxi cost determination control unit 102 may shorten a duration of constant taxi speed so that the roll-out meets a maximum required taxi time.

As described, the taxi cost determination control unit 102 is configured to determine the lowest (or minimum) cost available taxi scenario. The taxi cost determination control unit 102 may define the cost function, such as the total taxi cost, as described herein. The taxi cost determination control unit 102 may identify dependent variables for each cost factor, such as thrust and time for fuel cost and engine cost, and time for maintenance cost and crew cost.

The taxi cost determination control unit 102 may also account for the boundary conditions. For example, various boundary conditions, such as engine warmup, time constraints (minimum time to taxi and maximum time to taxi), and stop bars may be assessed by the taxi cost determination control unit in relation to discarding certain taxi scenarios as unavailable. For example, if a taxi scenario does not allow for sufficient engine warmup, the taxi cost determination control unit 102 may discard the taxi scenario as unavailable. As another example, if a taxi scenario takes too long (for example, beyond a scheduled departure time), the taxi cost determination control unit 102 may discard the taxi scenario as unavailable. As another example, if a taxi scenario does not account of a required stop time at stop bars, the taxi cost determination control unit 102 may discard the taxi scenario as unavailable.

As noted, if an aircraft taxies fast, costs growing with time may be less, but fuel and engine wear costs may increase. The taxi cost determination control unit 102 analyzes large amounts of data to determine available taxi scenarios that allow an operator to determine whether any savings generated by taxiing fast overcome fuel costs and engine costs. Conversely, while taxiing slowly may save fuel costs and engine costs, a total taxiing time is increased. The taxi cost determination control unit 102 determines the available taxi scenarios to allow the operator to determine whether fuel cost and engine cost are overcome, or rendered moot, by a taxi time that is too long. In short, the taxi costs determination control unit defines the total taxi cost to account for each of fuel cost, engine cost, maintenance cost, and crew cost, thereby accounting for various (in at least one embodiment, all) costs to allow for determination of a comprehensive cost-effective taxi strategy.

FIG. 11 is a diagrammatic representation of a front view of the display 104 showing available taxi scenarios 400a and 400b, according to an embodiment of the present disclosure. In at least one embodiment, the taxi cost determination control unit 102 may output multiple available taxi scenarios, such as 400a and 400b, to provide a pilot different taxiing strategy options. As shown, the available taxi scenario 400a indicates a start time at 12:00, with a wait at a stop bar for 2 minutes, and a total taxi cost. In contrast, the available taxi scenario 400b indicates a start time of 12:02, with no wait at the stop bar, and a reduced total taxi cost. The total taxi cost of the available taxi scenario 400b is less than that of the available taxi scenario 400a due to the aircraft idling at the gate for two extra minutes (instead of taxiing, stopping, and re-accelerating to taxiing speed). Accordingly, a pilot may choose the available taxi scenario 400b over the available taxi scenario 400a.

As used herein, the term “control unit,” “central processing unit,” “unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the taxi cost determination control unit 102 may be or include one or more processors that are configured to control operation thereof, as described herein.

The taxi cost determination control unit 102 is configured to execute a set of instructions that are stored in one or more data storage units or elements (such as one or more memories), in order to process data. For example, the taxi cost determination control unit 102 may include or be coupled to one or more memories. The data storage units may also store data or other information as desired or needed. The data storage units may be in the form of an information source or a physical memory element within a processing machine.

The set of instructions may include various commands that instruct the taxi cost determination control unit 102 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units, such as the taxi cost determination control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the taxi cost determination control unit 102 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

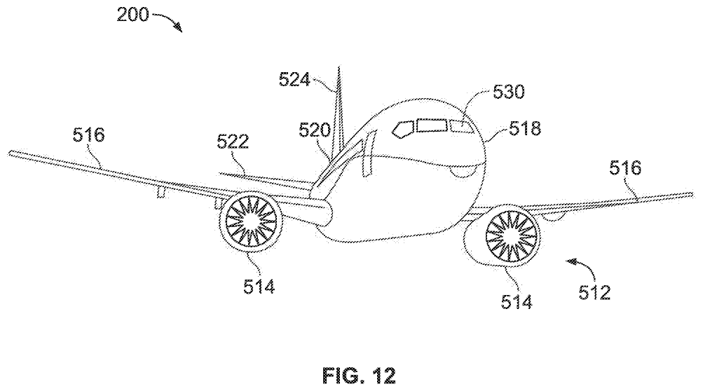

FIG. 12 is a diagrammatic representation of a front perspective view of the aircraft 200, according to an exemplary embodiment of the present disclosure. The aircraft 200 includes a propulsion system 512 that may include two turbofan engines 514, for example. Optionally, the propulsion system 512 may include more engines 514 than shown. The engines 514 are carried by wings 516 of the aircraft 200. In other embodiments, the engines 514 may be carried by a fuselage 518 and/or an empennage 520. The empennage 520 may also support horizontal stabilizers 522 and a vertical stabilizer 524. The fuselage 518 of the aircraft 200 defines an internal cabin, which may include a cockpit 530.

The aircraft 200 may be sized, shaped, and configured other than shown in FIG. 12. For example, the aircraft 200 may be a non-fixed wing aircraft, such as a helicopter. As another example, the aircraft 200 may be an unmanned aerial vehicle (UAV).

Referring to FIGS. 1-12, embodiments of the present disclosure provide systems and methods that allow large amounts of data to be quickly and efficiently analyzed by a computing device. For example, numerous aircraft 200 may be scheduled to fly between different airports on any given day. A tremendous amount of possible taxiing scenarios may exist for each aircraft at an airport. As such, large amounts of data are being tracked and analyzed. The vast amounts of data are efficiently organized and/or analyzed by the taxi cost determination control unit 102, as described herein. The taxi cost determination control unit 102 analyzes the data in a relatively short time in order to quickly and efficiently output and/or display efficient routes. A human being would be incapable of efficiently analyzing such vast amounts of data in such a short time. As such, embodiments of the present disclosure provide increased and efficient functionality with respect to prior computing systems, and vastly superior performance in relation to a human being analyzing the vast amounts of data. In short, embodiments of the present disclosure provide systems and methods that analyze thousands, if not millions, of calculations and computations that a human being is incapable of efficiently, effectively and accurately managing.

As described herein, embodiments of the present disclosure provide systems and methods for determining various taxiing options for aircraft. Further, embodiments of the present disclosure provide systems and methods for providing costs for various taxiing scenarios.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

1. An aircraft taxi cost determination system, comprising:
a taxi cost determination control unit that determines a total cost of one or more available taxi scenarios for an aircraft at an airport based on fuel cost, engine cost, crew cost, and maintenance cost for the one or more available taxi scenarios.

2. The aircraft taxi cost determination system of claim 1, further comprising an environmental sub-system that is in communication with the taxi cost determination control unit, wherein the environmental sub-system stores environmental data, and wherein the taxi cost determination control unit analyzes the environmental data when determining the total cost of the one or more available taxi scenarios.

3. The aircraft taxi cost determination system of claim 1, further comprising an airport database that is in communication with the taxi cost determination control unit, wherein the airport database stores airport data, and wherein the taxi cost determination control unit analyzes the airport data when determining the total cost of the one or more available taxi scenarios.

4. The aircraft taxi cost determination system of claim 1, further comprising an aircraft database that is in communication with the taxi cost determination control unit, wherein the aircraft database stores aircraft data regarding the aircraft, and wherein the taxi cost determination control unit analyzes the aircraft data when determining the total cost of the one or more available taxi scenarios.

5. The aircraft taxi cost determination system of claim 1, further comprising a flight schedule sub-system that is in communication with the taxi cost determination control unit, wherein the flight schedule sub-system stores flight schedule data for the airport, and wherein the taxi cost determination control unit analyzes the flight schedule data when determining the total cost of the one or more available taxi scenarios.

6. The aircraft taxi cost determination system of claim 1, wherein the taxi cost determination control unit accounts for engine warm-up time for the aircraft when determining the total cost of the one or more available taxi scenarios.

7. The aircraft taxi cost determination system of claim 1, wherein the taxi cost determination control unit accounts for a required time frame within which the aircraft is required to take off when determining the total cost of the one or more available taxi scenarios.

8. The aircraft taxi cost determination system of claim 1, wherein the taxi cost determination control unit accounts for a number of stop bars on a taxiway when determining the total cost of the one or more available taxi scenarios.

9. The aircraft taxi cost determination system of claim 1, wherein the taxi cost determination control unit establishes possible taxi scenarios based on one or more of environmental data, taxi data, aircraft data, airport data, or flight schedule data.

10. The aircraft taxi cost determination system of claim 9, wherein the taxi cost determination control unit discards one or more possible taxi scenarios that are outside of a required time frame as one or more unavailable taxi scenarios.

11. The aircraft taxi cost determination system of claim 10, wherein the taxi cost determination control unit identifies one or more possible taxi scenarios that are within the required time frame as the one or more available taxi scenarios.

12. The aircraft taxi cost determination system of claim 11, wherein the taxi cost determination control unit identifies a lowest cost available taxi scenario within the one or more available taxi scenarios.

13. An aircraft taxi cost determination method, comprising:
determining, by a taxi cost determination control unit, a total cost of one or more available taxi scenarios for an aircraft at an airport based on fuel cost, engine cost, crew cost, and maintenance cost for the one or more available taxi scenarios.

14. The aircraft taxi cost determination method of claim 13, further comprising analyzing, by the taxi cost determination control unit, environmental data during the determining.

15. The aircraft taxi cost determination method of claim 13, further comprising analyzing, by the taxi cost determination control unit, airport data during the determining.

16. The aircraft taxi cost determination method of claim 13, further comprising analyzing, by the taxi cost determination control unit, aircraft data during the determining.

17. The aircraft taxi cost determination method of claim 13, further comprising analyzing, by the taxi cost determination control unit, flight schedule data during the determining.

18. The aircraft taxi cost determination method of claim 13, further comprising accounting for, by the taxi cost determination control unit, one or more of engine warm-up time for the aircraft, a required time frame within which the aircraft is required to take off, or a number of stop bars on a taxiway during the determining.

19. The aircraft taxi cost determination method of claim 13, wherein the determining comprises:
establishing possible taxi scenarios based on one or more of environmental data, taxi data, aircraft data, airport data, or flight schedule data;
discarding one or more possible taxi scenarios that are outside of a required time frame as one or more unavailable taxi scenarios;
identifying one or more possible taxi scenarios that are within the required time frame as the one or more available taxi scenarios; and
identifying a lowest cost available taxi scenario within the one or more available taxi scenarios.

20. An aircraft taxi cost determination system, comprising:
a taxi cost determination control unit that determines a total cost of one or more available taxi scenarios for an aircraft at an airport based on fuel cost, engine cost, crew cost, and maintenance cost for the one or more available taxi scenarios, wherein the taxi cost determination control unit accounts for engine warm-up time for the aircraft, a required time frame within which the aircraft is required to take off, and a number of stop bars on a taxiway when determining the total cost of the one or more available taxi scenarios;
an environmental sub-system in communication with the taxi cost determination control unit, wherein the environmental sub-system stores environmental data, wherein the taxi cost determination control unit analyzes the environmental data when determining the total cost of the one or more available taxi scenarios;
an airport database in communication with the taxi cost determination control unit, wherein the airport database stores airport data, wherein the taxi cost determination control unit analyzes the airport data when determining the total cost of one or more available taxi scenarios;
an aircraft database in communication with the taxi cost determination control unit, wherein the aircraft database stores aircraft data regarding the aircraft, wherein the taxi cost determination control unit analyzes the aircraft data when determining the total cost of the one or more available taxi scenarios;
a flight schedule sub-system in communication with the taxi cost determination control unit, wherein the flight schedule sub-system stores flight schedule data for the airport, wherein the taxi cost determination control unit analyzes the flight schedule data when determining the total cost of the one or more available taxi scenarios.

21. The aircraft taxi cost determination system of claim 20, wherein the taxi cost determination control unit:
establishes possible taxi scenarios based on one or more of the environmental data, the aircraft data, the airport data, or the flight schedule data,
discards one or more possible taxi scenarios that are outside of a required time frame as one or more unavailable taxi scenarios,
identifies one or more possible taxi scenarios that are within the required time frame as the one or more available taxi scenarios, and
identifies a lowest cost available taxi scenario within the one or more available taxi scenarios.
